(19) United States
(12) Patent Application Publication
(10) Pub. No.: US 2025/0239192 A1
(43) Pub. Date: Jul. 24, 2025

(54) DISPLAY DEVICE AND DRIVING METHOD OF THE SAME

(71) Applicant: LG Display Co., Ltd., Seoul (KR)

(72) Inventor: Moo Kyoung HONG, Paju-si (KR)

(21) Appl. No.: 18/944,891

(22) Filed: Nov. 12, 2024

(30) Foreign Application Priority Data
Jan. 22, 2024 (KR) 10-2024-0009333

(51) Int. Cl. G09G 3/00; G09G 3/3233

(52) U.S. Cl. CPC G09G 3/006; G09G 3/3233; G09G 2300/0842; G09G 2330/04; G09G 2330/12

(57) ABSTRACT

Disclosed is a display device including a display panel for displaying images, a voltage circuit configured to apply a reference voltage lower than high power for driving the display panel to the display panel before the high power is applied, a sensor configured to sense the reference voltage applied to the display panel before the high power is applied to the display panel to provide a reference voltage sensing value, and a controller configured to diagnose a state of the display panel on the basis of the reference voltage sensing value.

### CROSS-REFERENCE TO RELATED APPLICATION(S)

This application claims the benefit of Korean Patent Application No. 10-2024-0009333, filed on Jan. 22, 2024, which is hereby incorporated by reference as if fully set forth herein.

### BACKGROUND

### Technical Field

The present disclosure relates to a display device and a method of driving the same.

### Description of the Related Art

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including subpixels, a driver outputting driving signals for driving the display panel, and a power supply for generating power to be supplied to the display panel or the driver.

In such display devices, when driving signals, for example, a scan signal and a data signal, are supplied to subpixels formed in a display panel, selected subpixels transmit light or directly emit light, thereby displaying an image.

### BRIEF SUMMARY

The present disclosure is directed to a display device and a method of driving the same that, among others, substantially obviate one or more problems due to limitations and disadvantages of the related art.

The present disclosure, among others, prevents damage to a display device in advance by applying a reference voltage lower than high power to drive a display panel to the display panel before the high power is applied and sensing the voltage again to detect the presence or absence of a defect in the display panel. In addition, an object of the present disclosure is to detect the presence or absence of a defect in the device under relatively stable conditions by applying the reference voltage lower than the high power to the display panel and sensing the same to detect short circuits in elements included in the display panel, defects in signal lines, current leakage, and the like and preparing accordingly.

Additional technical characteristics and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

To achieve these technical characteristics and other improvements and in accordance with the purpose of the present disclosure, as embodied and broadly described herein, a display device includes a display panel configured to display images, a voltage circuit configured to apply a reference voltage lower than high power for driving the display panel to the display panel before the high power is applied, a sensor configured to sense the reference voltage applied to the display panel before the high power is applied to the display panel to provide a reference voltage sensing value, and a controller configured to diagnose a state of the display panel on the basis of the reference voltage sensing value.

The voltage circuit may apply the reference voltage through a reference line connected to a subpixel of the display panel.

The sensor may sense the reference voltage through a power line connected to the subpixel of the display panel.

The sensor may sense the reference voltage through the power line when the reference voltage applied through the reference line is transmitted through the power line of the display panel according to operation of a driving transistor included in the subpixel of the display panel.

The sensor may be included in a power supply for generating the high power.

The sensor may sense the reference voltage charged in the reference line when transistors included in the subpixel of the display panel are in a non-driving state.

The sensor may be included in a data driver connected to the subpixel of the display panel.

The controller may determine the display panel to be in an abnormal state when the reference voltage sensing value is detected as a level below an internally set reference value.

In another aspect of the present disclosure, a method of driving a display device includes applying power to the display device and applying a reference voltage lower than high power to a display panel before the high power is applied to the display panel, sensing the reference voltage applied to the display panel before the high power is applied to the display panel to provide a reference voltage sensing value, and diagnosing a state of the display panel on the basis of the reference voltage sensing value.

The reference voltage may be sensed through a power line connected to a subpixel of the display panel or through a reference line connected to the subpixel of the display panel.

It is to be understood that both the foregoing general description and the following detailed description of the present disclosure are exemplary and explanatory and are intended to provide further explanation of the present disclosure.

### BRIEF DESCRIPTION OF THE SEVERAL VIEWS OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light emitting display device, FIG. 2 is a configuration diagram schematically showing a subpixel shown in FIG. 1, and FIG. 3 is a diagram illustrating a pixel composed of subpixels;

FIG. 4 and FIG. 5 are diagrams illustrating the configuration of a gate-in-panel type gate driver, and FIG. 6 is a diagram showing an example of the arrangement of the gate-in-panel type gate driver;

FIG. 7 is a diagram schematically showing a subpixel and a data driver according to a first example of an embodiment, FIG. 8 is a diagram schematically showing a subpixel and a data driver according to a second example of the embodiment, and FIG. 9 is a waveform diagram illustrating a sensing period and a display period according to the embodiment;

FIG. 10 is a diagram showing some of components included in the data driver according to the embodiment in more detail, and FIG. 11 and FIG. 12 are diagrams showing a method of sensing a display panel according to the embodiment;

FIG. 13 is a diagram schematically illustrating a light emitting display device according to a first embodiment, FIG. 14 and FIG. 15 are diagrams illustrating the configuration of a power supply and a power-on sequence according to the first embodiment, FIG. 16 is a waveform diagram illustrating a reference voltage detection method according to the first embodiment, FIG. 17 to FIG. 19 are diagrams showing device operating states to aid in understanding the reference voltage detection method illustrated in FIG. 16, and FIG. 20 is a diagram showing internal blocks of the power supply according to the first embodiment;

FIG. 21 is a diagram schematically illustrating a light emitting display device according to a second embodiment, FIG. 22 is a waveform diagram illustrating a reference voltage detection method according to the second embodiment, and FIG. 23 to FIG. 25 are diagrams showing device operating states to aid in understanding the reference voltage detection method illustrated in FIG. 22; and

FIG. 26 is a flowchart illustrating a reference voltage detection method according to a third embodiment.

### DETAILED DESCRIPTION

A display device according to the present disclosure may be implemented as a television system, an image player, a personal computer (PC), a home theater, an automobile electric device, a smartphone, or the like, but is not limited thereto. The display device according to the present disclosure may be implemented as a light emitting display (LED) device, a quantum dot display (QDD) device, a liquid crystal display (LCD) device, or the like. However, for convenience of description, as an example, a light emitting display device that directly emits light based on inorganic light emitting diodes or organic light emitting diodes will be described below.

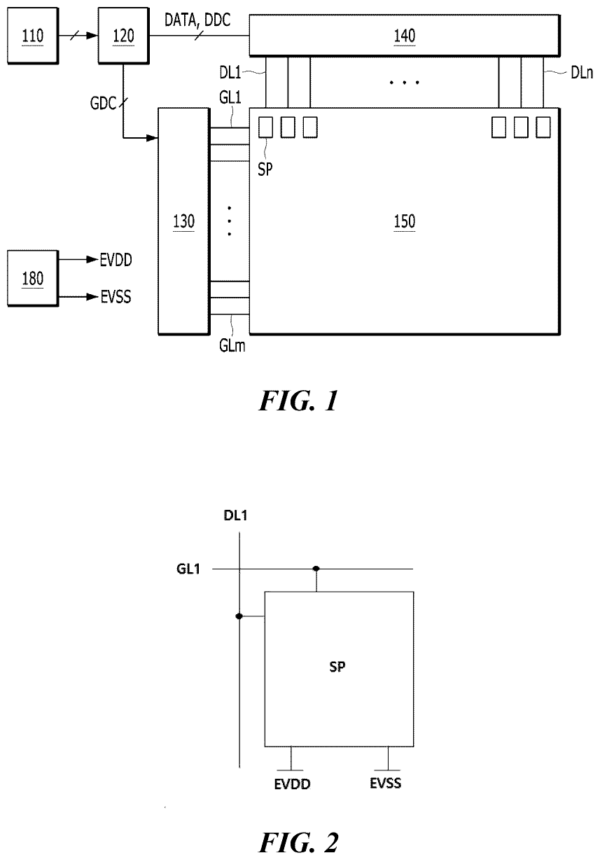

FIG. 1 is a block diagram schematically showing a light emitting display device, FIG. 2 is a configuration diagram schematically showing a subpixel shown in FIG. 1, and FIG. 3 is a diagram showing a pixel composed of subpixels.

As illustrated in FIG. 1, FIG. 2, and FIG. 3, the light emitting display device may include a timing controller 120, a gate driver 130, a data driver 140, a display panel 150, a power supply 180, and the like.

An image provider 110 (a set or a host system) may output various driving signals along with an externally supplied image data signal or an image data signal stored in an internal memory. The image provider 110 may supply data signals and various driving signals to the timing controller 120.

The timing controller 120 may output a gate timing control signal GDC for controlling the operation timing of the gate driver 130, a data timing control signal DDC for controlling the operation timing of the data driver 140, and various synchronization signals. The timing controller 120 may supply a data signal DATA supplied from the image provider 110 to the data driver 140 along with the data timing control signal DDC. The timing controller 120 may be implemented in the form of an integrated circuit (IC) and mounted on a printed circuit board, but is not limited thereto.

The gate driver 130 may output a gate signal (or a gate voltage) in response to the gate timing control signal GDC supplied from the timing controller 120. The gate driver 130 may supply gate signals to subpixels included in the display panel 150 through gate lines GL1 to GLm. The gate driver 130 may be implemented in the form of an IC or directly formed on the display panel 150 in a gate-in-panel structure, but is not limited thereto.

The data driver 140 may sample and latch the data signal DATA in response to the data timing control signal DDC supplied from the timing controller 120, convert the digital data signal into an analog data voltage on the basis of a gamma reference voltage, and output the analog data voltage. The data driver 140 may supply data voltages to the subpixels included in the display panel 150 through data lines DL1 to DLn. The data driver 140 may be implemented in the form of an integrated circuit (IC) and mounted on the display panel 150 or mounted on a printed circuit board, but is not limited thereto.

The power supply 180 can generate first power at a high level and second power at a low level on the basis of an external input voltage supplied from the outside. The power supply 180 may output the first power through a first power line EVDD and output the second power through a second power line EVSS. The power supply 180 may generate and output power (e.g., a scan high voltage and a scan low voltage) to drive the gate driver 130 and power (e.g., a drain voltage and a half drain voltage) to drive the data driver 140 as well as the first power and the second power.

The display panel 150 may display an image in response to driving signals including a scan signal and a data voltage, the first power, and the second power. The subpixels of the display panel 150 may directly emit light. The display panel 150 may be manufactured based on a substrate having rigidity or flexibility, such as glass, silicon, polyimide, or the like. For example, one subpixel SP may be connected to the first data line DL1, the first gate line GL1, the first power line EVDD, and the second power line EVSS and may include a pixel circuit including a switching transistor, a driving transistor, a capacitor, an organic light emitting diode, etc.

Subpixels SP used in the light-emitting display device directly emit light, and thus the circuit configuration thereof is complicated. In addition, there are various compensation circuits that compensate for deterioration (in the threshold voltage, mobility, etc.) of not only the organic light emitting diode emitting light but also the driving transistor that supplies a driving current to drive the organic light emitting diode. Therefore, the subpixel SP is simply shown in the form of a block.

Subpixels emitting light may be composed of red, green, and blue pixels or red, green, blue, and white pixels. For example, one pixel P may include a red subpixel SPR connected to the first data line DL1, a white subpixel SPW connected to the second data line DL2, a green subpixel SPG connected to the third data line DL3, and a blue subpixel SPB connected to the fourth data line DL4. Additionally, the red subpixel SPR, white subpixel SPW, green subpixel SPG, and blue subpixel SPB may be commonly connected to a first reference line VREF1. The first reference line VREF1 may be used to sense deterioration of elements included in one of the red subpixel SPR, white subpixel SPW, green subpixel SPG, and blue subpixel SPB, which will be described below.

Meanwhile, the timing controller 120, the gate driver 130, and the data driver 140 have been described as individual components. However, depending on the implementation method of the light emitting display device, one or more of the timing controller 120, the gate driver 130, and the data driver 140 may be integrated into a single IC. In addition, the timing controller 120, the gate driver 130, the data driver 140, the power supply 180, and the display panel 150 are an assembly for displaying images and may be defined as a display module.

In addition, as an example, the pixels P in which the red subpixel SPR, white subpixel SPW, green subpixel SPG, and blue subpixel SPB are arranged in order has been illustrated. However, the arrangement order and direction of subpixels may vary depending on the implementation method of the light emitting display device.

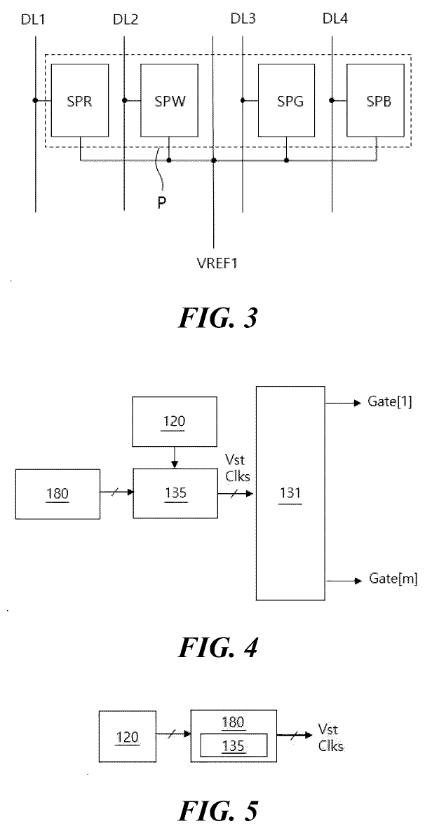

FIG. 4 and FIG. 5 are diagrams illustrating the configuration of a gate-in-panel type gate driver, and FIG. 6 is a diagram showing an example of the arrangement of the gate-in-panel type gate driver.

As shown in FIG. 4, the gate-in-panel type gate driver may include a shift register 131 and a level shifter 135. The level shifter 135 may generate driving clock signals Clks and a start signal Vst on the basis of signals and voltages output from the timing controller 120 and the power supply 180.

The shift register 131 operates on the basis of signals Clks and Vst output from the level shifter 135, and may output gate signals Gate[1] to Gate[m] for turning on or off transistors formed in the display panel. The shift register 131 may take the form of a thin film on the display panel in a gate-in-panel structure.

As shown in FIG. 4 and FIG. 5, unlike the shift register 131, the level shifter 135 may be formed independently in the form of an IC or may be included in the power supply 180. However, this is merely an example and is not limited to thereto.

As shown in FIG. 6, shift registers 131a and 131b that output gate signals in the gate-in-panel type gate driver may be disposed in a non-display area NA of the display panel 150. As an example, the shift registers 131a and 131b are disposed in the left and right non-display areas NA of the display panel 150, but the shift registers 131a and 131b may also be disposed in upper and lower non-display areas NA of the display panel 150 or may be disposed within a display area AA of the display panel 150.

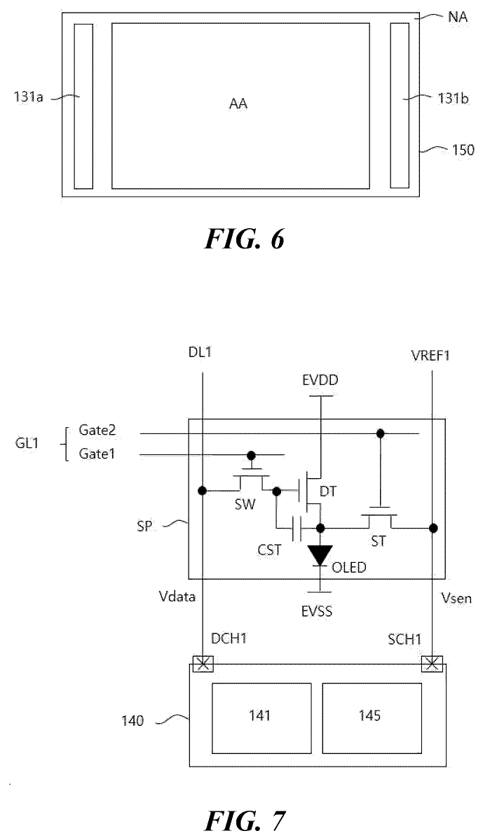

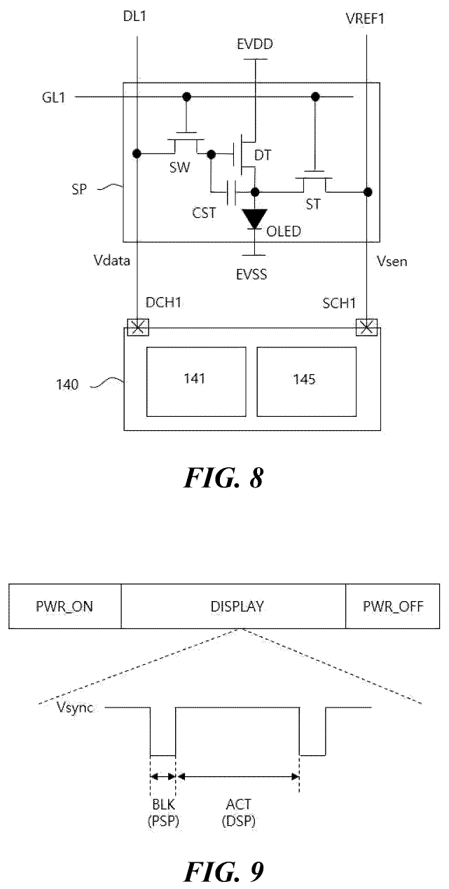

FIG. 7 is a diagram schematically showing a subpixel and a data driver according to a first example of an embodiment, FIG. 8 is a diagram schematically showing a subpixel and a data driver according to a second example of the embodiment, and FIG. 9 is a waveform diagram illustrating a sensing period and a display period.

As shown in FIG. 7, according to the first example, one subpixel SP may include a switching transistor SW, a driving transistor DT, a sensing transistor ST, a capacitor CST, and an organic light emitting diode OLED.

The driving transistor DT may include a gate electrode connected to a first electrode of the capacitor CST, a first electrode connected to the first power line EVDD, and a second electrode connected to the anode of the organic light emitting diode OLED. The capacitor CST may have the first electrode connected to the gate electrode of the driving transistor DT and a second electrode connected to the anode electrode of the organic light emitting diode OLED. The organic light emitting diode OLED may have the anode connected to the second electrode of the driving transistor DT and a cathode connected to the second power line EVSS.

The switching transistor SW may include a gate electrode connected to a first scan line Gate1 included in the first gate line GL1, a first electrode connected to the first data line DL1, and a second electrode connected to the gate electrode of the driving transistor DT. The sensing transistor ST may include a gate electrode connected to a second scan line Gate2 included in the first gate line GL1, a first electrode connected to the first reference line VREF1, and a second electrode connected to the anode of the organic light emitting diode OLED.

The sensing transistor ST is a kind of compensation circuit added to compensate for deterioration of the driving transistor DT or the organic light emitting diode OLED. The sensing transistor ST can enable physical threshold voltage sensing based on the source follower operation of the driving transistor DT. The sensing transistor ST can operate to acquire a sensing voltage through a sensing node defined between the driving transistor DT and the organic light emitting diode OLED.

According to an embodiment, the data driver 140 may include a driving circuit 141 for driving the subpixel SP and a sensing circuit 145 for sensing the subpixel SP. The driving circuit 141 may be connected to the first data line DL1 through a first data channel DCH1. The driving circuit 141 may output a data voltage Vdata for driving the subpixel SP through the first data channel DCH1.

The sensing circuit 145 may be connected to the first reference line VREF1 through a first sensing channel SCH1. The sensing circuit 145 may acquire a sensing voltage Vsen sensed from the subpixel SP through the first sensing channel SCH1. The sensing circuit 145 may acquire the sensing voltage Vsen based on a current sensing or voltage sensing method.

As shown in FIG. 8, according to the second example, the first gate line GL1 may be integrated into one. That is, unlike the first example, the first gate line GL1 may not be divided into the first scan line and the second scan line. In this case, the switching transistor SW and the sensing transistor ST are commonly connected to the first gate line GL1, and thus can be turned on or off at the same time.

As shown in FIG. 9, the light emitting display device according to the embodiment may adopt driving modes respectively corresponding to a first driving period PWR_ON, a second driving period DISPLAY, and a third driving period PWR_OFF when operating to drive the display panel.

The first driving period PWR_ON may correspond to a driving start period in which power is applied to the display panel, the second driving period DISPLAY may correspond to a panel driving period in which operation such as displaying an image is performed after the power is applied to the display panel, and a third driving period PWR_OFF may correspond to a driving end period in which the power applied to the display panel is cut off. Meanwhile, the third driving period PWR_OFF is a period in which the display panel is driven for a certain period of time while displaying black such that the sensing operation of the display panel can be performed. That is, note that the power applied to the display panel and the like is not completely cut off during the third driving period PWR_OFF.

The light emitting display device according to the embodiment may sense the display panel in at least one of the first drive period PWR_ON, the second drive period DISPLAY, and the third drive period PWR_OFF. As an example, in the second driving period DISPLAY, a blank period BLK included in the vertical synchronization signal Vsync may be defined as a sensing period PSP, and an active period ACT included in the vertical synchronization signal Vsync may be defined as a display period DSP.

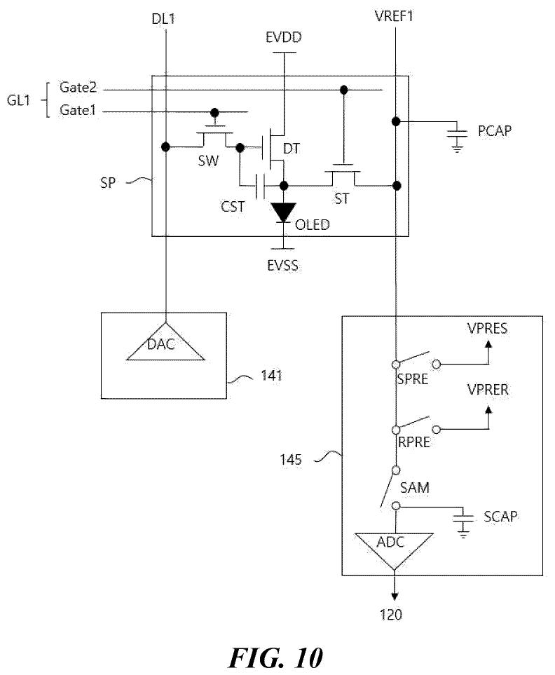

FIG. 10 is a diagram showing some of the components included in the data driver according to an embodiment in more detail, and FIG. 11 and FIG. 12 are diagrams showing a method of sensing the display panel according to the embodiment. Hereinafter, as an example, the structure of the subpixel SP shown in FIG. 7 will be described.

As in the embodiment shown in FIG. 10, the driving circuit 141 may include a digital-to-analog converter DAC to output a sensing data voltage, a black data voltage, or a display data voltage through the first data line DL1. The sensing circuit 145 may include a first voltage circuit SPRE, a second voltage circuit RPRE, a sampling circuit SAM, and an analog-to-digital converter ADC to output and sense a voltage through the first reference line VREF1.

The first voltage circuit SPRE and the second voltage circuit RPRE may perform a voltage output operation to initialize nodes or circuits included in the subpixel SP or charge the same to a specific voltage level. The first voltage circuit SPRE and the second voltage circuit RPRE may include a first reference voltage source VPRES and a second reference voltage source VPRER, respectively. The first voltage circuit SPRE may output a first reference voltage on the basis of the first reference voltage source VPRES, and the second voltage circuit RPRE may output a second reference voltage on the basis of the second reference voltage source VPRER.

The first reference voltage may be defined as a voltage used to initialize a sensing node to which the source electrode of the driving transistor DT and the second electrode of the capacitor CST are connected. The second reference voltage may be defined as a voltage used to compensate for a decrease in the luminance of a sensing target subpixel. Accordingly, the first reference voltage for initializing the sensing node may be set to a voltage lower than the second reference voltage.

The sampling circuit SAM can perform a sampling operation to acquire a sensing voltage through the first reference line VREF1. For example, the sampling circuit SAM may acquire the sensing voltage from a sensing capacitor PCAP formed on the first reference line VREF1 on the basis of the sensing capacitor PCAP.

The analog-to-digital converter ADC can convert the analog sensing voltage acquired by the sampling circuit SAM into a digital sensing voltage and output the same. For example, the analog-to-digital converter ADC can convert the analog sensing voltage charged in the sensing capacitor PCAP into a digital sensing voltage and output the same.

The timing controller 120 may include a compensator that performs a compensation operation based on the sensing voltage (sensing data value) supplied from the sensing circuit 145. The compensator included in the timing controller 120 may determine whether the driving transistor DT or the organic light emitting diode OLED included in the subpixel SP has deteriorated on the basis of the sensing voltage and compensate for the deterioration.

As shown in FIG. 11, according to the first example, the light emitting display device may perform a sequential sensing method in which sensing is performed from the first gate line GL1 to the M-th gate line GLm of the display panel 150. Although FIG. 11 illustrates an example in which sensing is performed sequentially starting from the first gate line GL1, which is the top of the display panel 150, sensing may start from the M-th gate line GLm, which is the bottom of the display panel 150.

As shown in FIG. 12, according to the second example, the light emitting display device may perform a random sensing method in which only an I-th gate line GLi of the display panel 150 is sensed. Although FIG. 12 illustrates an example in which only the I-th gate line GLi, which is one of specific gate lines, is sensed, the sensing target may be two or more gate lines.

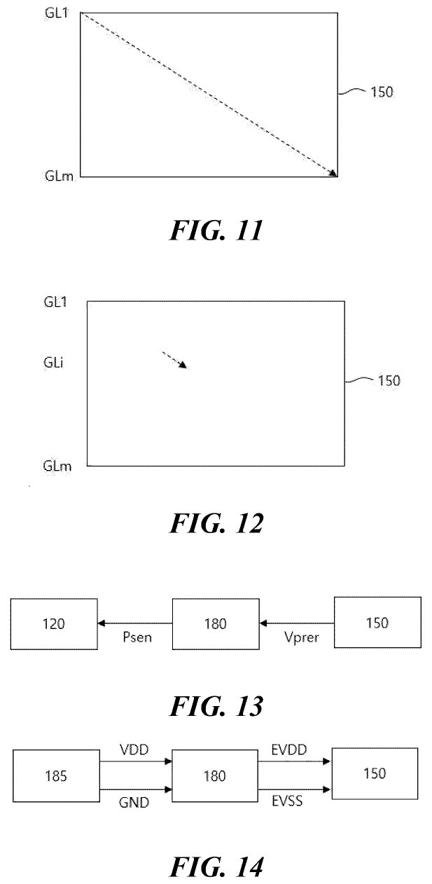

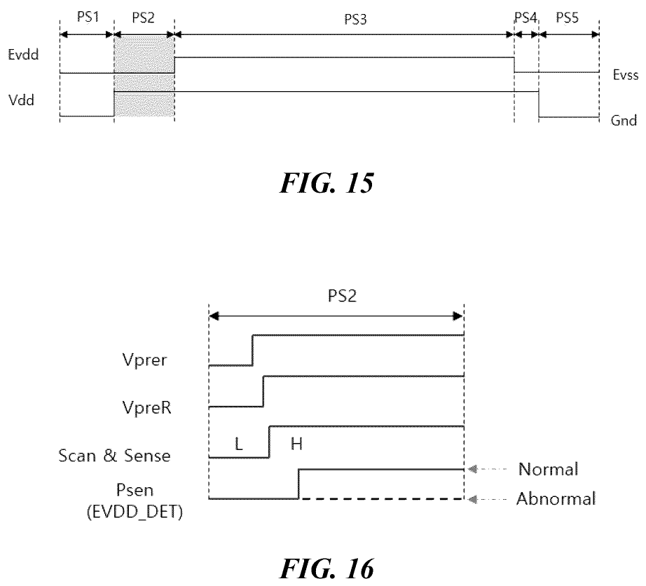

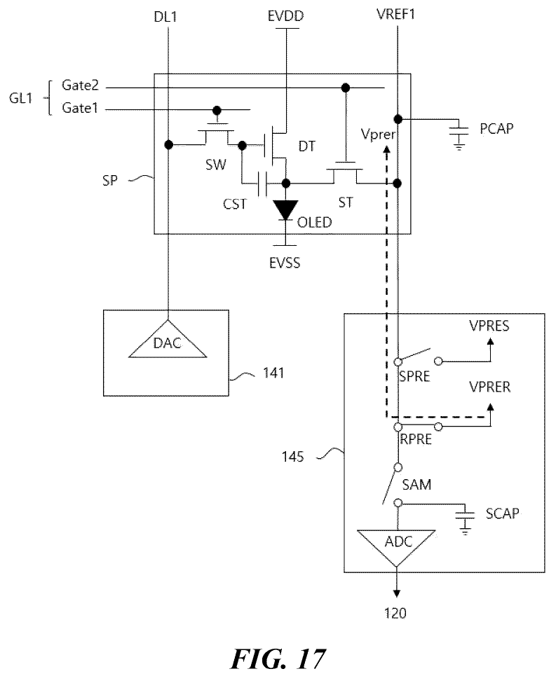

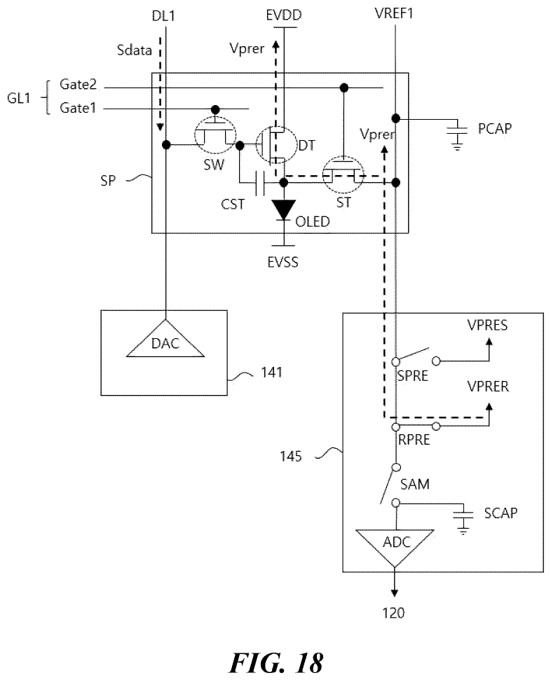

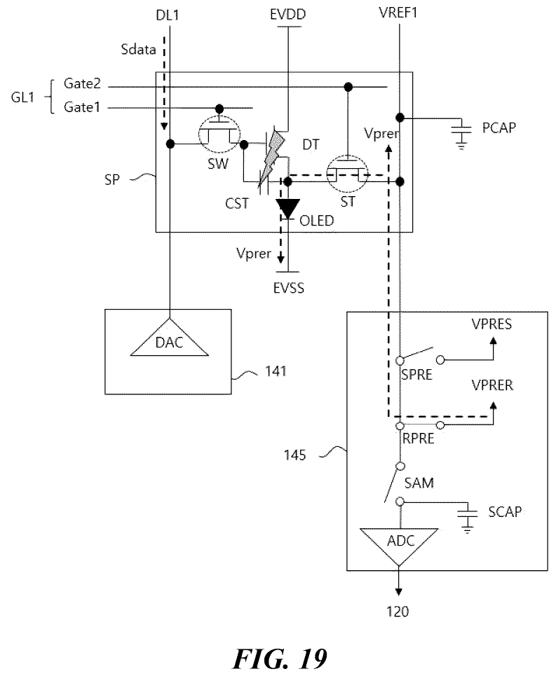

FIG. 13 is a diagram schematically illustrating a light emitting display device according to a first embodiment, FIG. 14 and FIG. 15 are diagrams illustrating the configuration of a power supply and a power-on sequence according to the first embodiment, FIG. 16 is a waveform diagram illustrating a reference voltage detection method according to the first embodiment, FIG. 17 to FIG. 19 are diagrams showing device operating states to aid in understanding the reference voltage detection method illustrated in FIG. 16, and FIG. 20 is a diagram showing internal blocks of the power supply according to the first embodiment.

As shown in FIG. 13, the light emitting display device according to the first embodiment may sense, for example, a second reference voltage Vprer among reference voltages applied to the display panel 150. The second reference voltage Vprer may be sensed by, for example, the power supply 180. The power supply 180 may sense the second reference voltage Vprer applied to the display panel 150 to provide a reference voltage sensing value Psen. The reference voltage sensing value Psen provided by the power supply 180 may be transmitted to the timing controller 120, for example. The timing controller 120 may diagnose the state of the display panel 150 (determine the presence or absence of a defect, and the like) on the basis of the reference voltage sensing value Psen transmitted from the power supply 180.

As shown in FIG. 14, according to the first embodiment, the power supply 180 provides the first power and the second power voltage to be supplied to the display panel 150 on the basis of third power and fourth power output from a main power supply 185. To this end, the output terminal of the main power supply 185 and the input terminal of the power supply 180 may be electrically connected by a third power line VDD and a fourth power line GND.

However, this is merely an example, and the power supply 180 and the main power supply 185 may be integrated. In this case, the power supply 180 may generate the third power and the fourth power on the basis of external power input from the outside, and generate the first power and the second power on the basis of the third power and the fourth power. For example, the third power may be defined as 12 V, and the first power may be defined as 20 V, which is higher than the third power. However, the power specifications for the light emitting display device may vary depending on the size and driving method, and thus the aforementioned numerical values should be interpreted as examples.

As shown in FIG. 15, when power is applied to the power supply during a first period PS1, a sequence in which the third power Vdd is generated during a second period PS2 and then the first power Evdd is generated during a third period PS3 may be provided. In addition, when the power applied to the power supply is cut off, a sequence in which the first power Evdd drops to the level of the second power Evss during a fourth period PS4 and then the third power Vdd drops to the level of the fourth power GND during a fifth period PS5 may be provided.

The light emitting display device according to the first embodiment can sense the second reference voltage applied to the display panel during the second period PS2 in which the first power Evdd is not generated (or not output), which will be described below. One subpixel will be described as a sensing target below. However, some or all subpixels of the display panel may be sensing target subpixels.

As shown in FIG. 13 to FIG. 19, during the second period PS2 in which the first power Evdd is not generated (or not output), the second reference voltage source VPRER included in the second voltage circuit RPRE of the sensing circuit 145 can prepare output of the second reference voltage Vprer.

The second voltage circuit RPRE connected to the first reference line VREF1 can be turned on in response to a second voltage circuit control signal VpreR at a high voltage. When the second voltage circuit RPRE is turned on, the second reference voltage Vprer can be applied to the first reference line VREF1 connected to the subpixel SP of the display panel as shown in FIG. 17. The second reference voltage Vprer applied to the first reference line VREF1 can be charged in the sensing capacitor PCAP of the first reference line VREF1.

A first scan signal and a first sensing signal and a first sensing signal Scan & Sense at a high voltage (on voltage) may be applied to the first scan line Gate1 and the second scan line Gate2 connected to the subpixel SP, and a sensing data voltage Sdata may be applied to the first data line DL1. When the sensing data voltage Sdata is applied along with the first scan signal and the first sensing signal Scan & Sense at the high voltage (on voltage), the switching transistor SW and the sensing transistor ST included in the subpixel SP of the display panel can be turned on as shown in FIG. 18. At this time, the driving transistor DT can operate as a switch in response to the sensing data voltage Sdata.

As the driving transistor DT operates as a switch, the second reference voltage Vprer applied through the first reference line VREF1 can be applied to the first power line EVDD through the source and drain electrodes of the driving transistor DT.

As described above, since the first power Evdd is not generated (or not output) during the second period PS2, the second reference voltage Vprer applied to the first power line EVDD can be detected by the sensing operation of the power supply 180.

The timing controller 120 may determine whether the display panel 150 is in a normal state or in an abnormal state on the basis of the reference voltage sensing value Psen (EVDD_DET represents a first power line detection value in FIG. 16) transmitted from the power supply 180. For example, if the reference voltage sensing value Psen is detected as a level similar or identical to the second reference voltage Vprer applied through the first reference line VREF1, the display panel 150 can be determined to be in a normal state. However, if the reference voltage sensing value Psen is detected as a level that is close to 0 (including cases where it is not sensed) or does not reach an internally set reference value, the display panel 150 can be determined to be in an abnormal state.

Meanwhile, as shown in FIG. 19, in a case where the switching transistor SW and the sensing transistor ST included in the subpixel SP are in a normal state, whereas the driving transistor DT or the capacitor CST has a problem (short circuit in an electrode, etc.), the second reference voltage Vprer may leak (discharge) through the second power line EVSS. In this case, the power supply 180 may provide the reference voltage sensing value Psen based on the second reference voltage Vprer sensed through the second power line EVSS. That is, the power supply 180 can sense the second reference voltage Vprer applied to the display panel not only through the first power line EVDD but also through the second power line EVSS.

As shown in FIG. 20, according to the first embodiment, the power supply 180 may include a power controller 181, a power generator 182, a power sensor 183, and a signal transmitter 184.

The power controller 181 may serve to control the power generator 182 such that the first power and the second power Evdd & Evss are generated on the basis of the input third power Vdd. The power generator 182 may serve to generate and output the first power and the second power Evdd & Evss on the basis of the third power Vdd under the control of the power controller 181.

The power sensor 183 may serve to convert an analog sensing value Sen obtained by sensing the second reference voltage Vprer applied to the display panel 150 into a digital sensing value Sen. The signal transmitter 184 may serve to configure the digital sensing value Sen output from the power sensor 183 as a reference voltage sensing value Psen and transmit the same to the timing controller 120 (e.g., through data communication). However, the configuration of the power supply 180 shown in FIG. 20 is merely intended to aid in understanding of the first embodiment.

Meanwhile, in the method according to the first embodiment, the sensing circuit is disposed inside the power supply 180, and thus the method can be easily applied to not only the structure in which the second power line and the fourth power line are separated, but also the structure in which the second power line and the fourth power line are integrated.

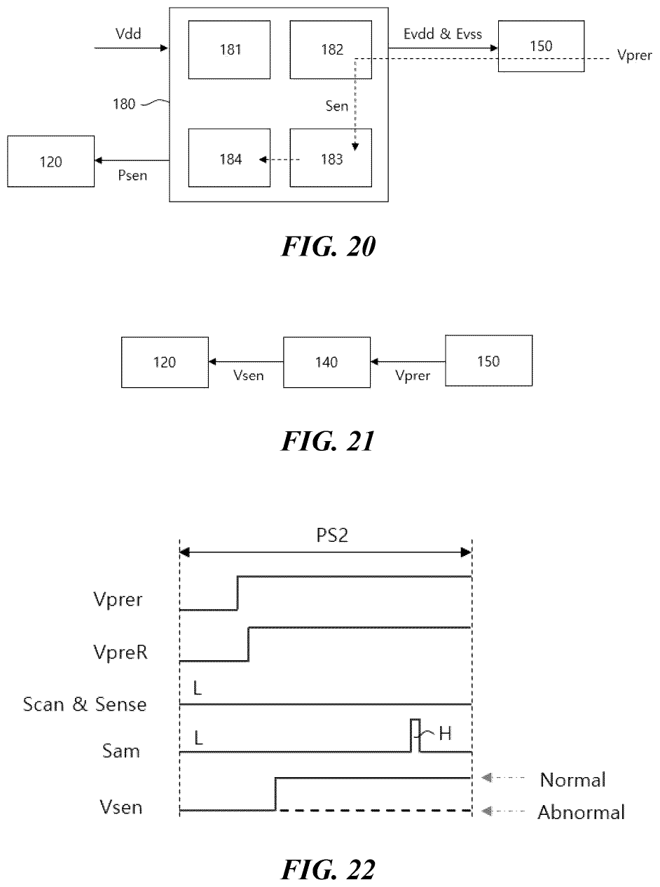

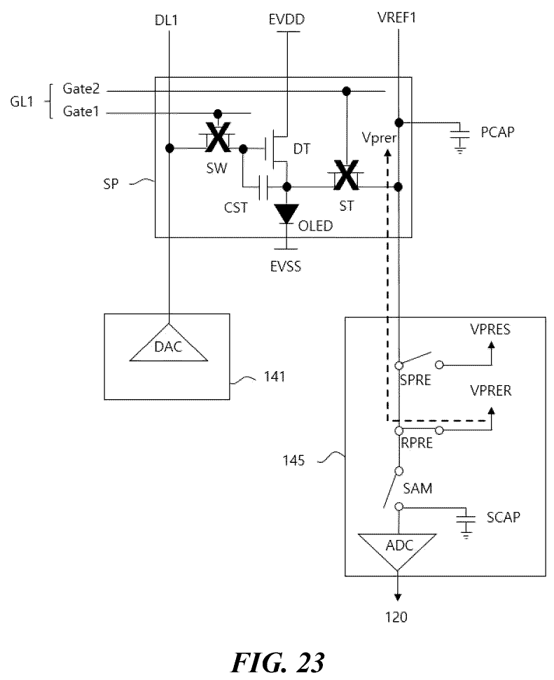

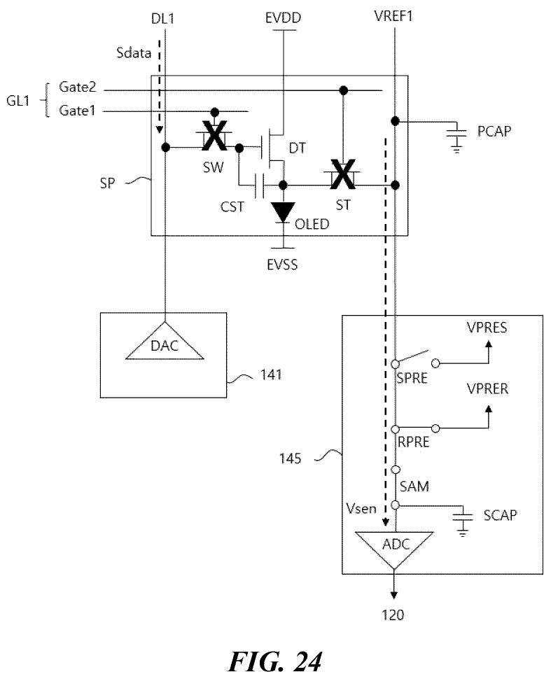

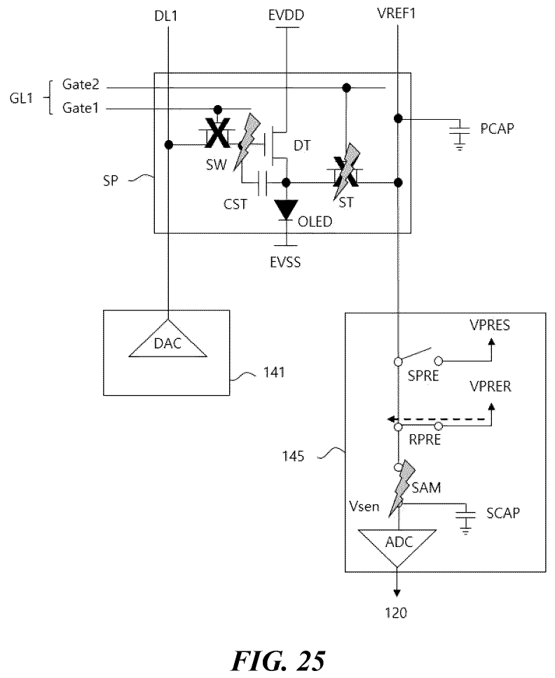

FIG. 21 is a diagram schematically illustrating a light emitting display device according to a second embodiment, FIG. 22 is a waveform diagram illustrating a reference voltage detection method according to the second embodiment, and FIG. 23 to FIG. 25 are diagrams showing device operating states to aid in understanding the reference voltage detection method described in FIG. 22.

As shown in FIG. 21, the light emitting display device according to the second embodiment can sense, for example, the second reference voltage Vprer among the reference voltages applied to the display panel 150. The second reference voltage Vprer may be sensed by, for example, the data driver 140. The data driver 140 may sense the second reference voltage Vprer applied to the display panel 150 to provide the reference voltage sensing value Vsen. The reference voltage sensing value Vsen provided by the data driver 140 may be transmitted to the timing controller 120, for example. The timing controller 120 may diagnose the state of the display panel 150 (determine the presence or absence of a defect, etc.) on the basis of the reference voltage sensing value Vsen transmitted from the data driver 140.

As in the first embodiment shown in FIG. 15, the light emitting display device according to the second embodiment can sense the second reference voltage applied to the display panel during the second period PS2 in which the first power Evdd is not generated (or not output), which will be described below. Hereinafter, one subpixel will be described as a sensing target. However, some or all subpixels of the display panel may be sensing targets.

As shown in FIG. 21 to FIG. 25, the second reference voltage source VPRER included in the second voltage circuit RPRE of the sensing circuit 145 can prepare output of the second reference voltage Vprer during the second period PS2 in which the first power is not generated (or not output).

The second voltage circuit RPRE connected to the first reference line VREF1 can be turned on in response to a second voltage circuit control signal VpreR at a high voltage. When the second voltage circuit RPRE is turned on, the second reference voltage Vprer can be applied to the first reference line VREF1 connected to the subpixel SP of the display panel as shown in FIG. 23. The second reference voltage Vprer applied to the first reference line VREF1 can be charged in the sensing capacitor PCAP of the first reference line VREF1.

A first scan signal and a first sensing signal Scan & Sense at a low voltage (off voltage) are applied to the first scan line Gate1 and the second scan line Gate2 connected to the subpixel SP, and the first data line DL1 may be in a floating state (a state in which no data voltage is applied). When the first scan signal and the first sensing signal Scan & Sense at the low voltage (off voltage) are applied, the switching transistor SW and the sensing transistor ST included in the subpixel SP of the display panel can be turned off as shown in FIG. 24. At this time, the driving transistor DT may be in a non-driving state.

The sampling circuit SAM connected to the first reference line VREF1 of the subpixel SP may be turned on in response to a sampling control signal Sam at a high voltage (on voltage). As the sampling circuit SAM is turned on, the second reference voltage Vprer charged in the sensing capacitor PCAP of the first reference line VREF1 can be sensed.

Meanwhile, as shown in FIG. 25, if there is a problem (short circuit in an electrode, etc.) in the switching transistor SW or the sensing transistor ST included in the subpixel SP, the second reference voltage Vprer may not be sensed normally. In this case, even if the sensing operation of the sampling circuit SAM is performed, the second reference voltage Vprer applied through the first reference line VREF1 is not charged (maintained) in a normal state and may leak (discharge) through another path (short-circuit path). Additionally, even when there is a problem in the sampling circuit SAM, the second reference voltage Vprer applied through the first reference line VREF1 may not be sensed.

The timing controller 120 may determine whether the display panel 150 is in a normal state or in an abnormal state on the basis of the reference voltage sensing value Vsen transmitted from the data driver 140. For example, if the reference voltage sensing value Vsen is detected as a level similar or identical to the second reference voltage Vprer applied through the first reference line VREF1, the display panel 150 can be determined to be in a normal state. However, if the reference voltage sensing value Vsen is detected as a level that is close to 0 (including cases where it is not sensed) or does not reach an internally set reference value, the display panel 150 can be determined to be in an abnormal state.

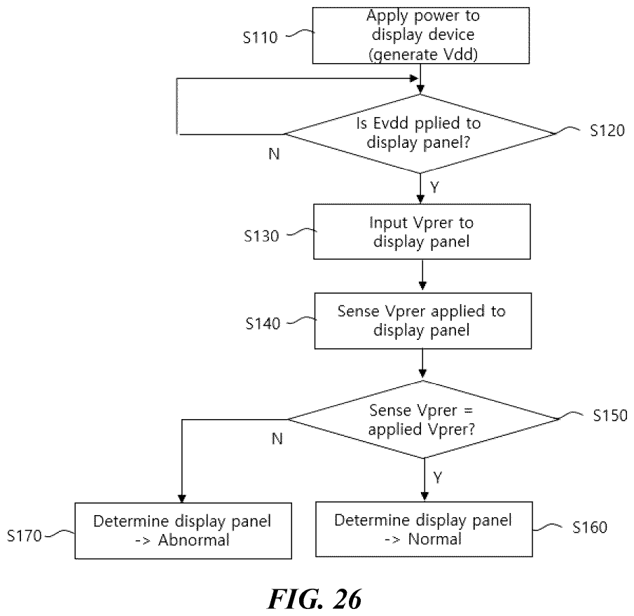

FIG. 26 is a flowchart illustrating a reference voltage detection method according to a third embodiment.

As shown in FIG. 26, according to the third embodiment, the method of detecting a reference voltage of the display device can be performed as flows.

First, power can be applied to the display device (S110). When power is applied to the display device, the power supply may generate the third power Vdd. Subsequently, it can be determined whether or not the first power Evdd is applied to the display panel (S120). Whether or not the first power Evdd is applied to the display panel may be determined by counting the time from generation of the third power Vdd to generation of the first power Evdd or by a method of sensing the circuit that generates the first power Evdd, but is not limited thereto.

Next, the second reference voltage Vprer can be applied to the display panel (S130). The second reference voltage Vprer may be generated by the power supply, a separate power circuit, or the data driver, but is not limited thereto.

Next, the second reference voltage Vprer applied to the display panel can be sensed (S140). The second reference voltage Vprer applied to the display panel may be sensed by the power supply as in the first embodiment, or may be sensed by the sensing circuit included in the data driver as in the second embodiment, but is not limited thereto.

Next, it can be determined whether or not the sensed second reference voltage Vprer is similar or identical to the second reference voltage Vprer applied to the display panel (S150). If the sensed second reference voltage Vprer is similar or identical to the second reference voltage Vprer applied to the display panel (Y), the display panel can be determined to be normal (S160). On the other hand, if the sensed second reference voltage Vprer is different from the second reference voltage Vprer applied to the display panel (N), the display panel can be determined to be abnormal (S170).

As described above, the present disclosure has the effect of preventing damage to the display device in advance by applying a reference voltage lower than high power to drive the display panel to the display panel before the high power is applied and sensing the voltage again to detect the presence or absence of a defect in the display panel. In addition, the present disclosure has the effect of detecting the presence or absence of a defect in the device under relatively stable conditions by applying the reference voltage lower than the high power to the display panel and sensing the same to detect short circuits in elements included in the display panel, defects in signal lines, current leakage, and the like and preparing accordingly.

It will be apparent to those skilled in the art that various modifications and variations can be made in the present disclosure without departing from the spirit or scope of the present disclosure. Thus, it is intended that the present disclosure cover the modifications and variations of the present disclosure including the appended claims and their equivalents.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel for displaying images;
a voltage circuit configured to apply a reference voltage to the display panel before a high power is applied for driving the display panel, the reference voltage lower than the high power;
a sensor configured to sense the reference voltage applied to the display panel before the high power is applied to the display panel to provide a reference voltage sensing value; and
a controller configured to diagnose a state of the display panel on the basis of the reference voltage sensing value.

2. The display device of claim 1, wherein the voltage circuit is configured to apply the reference voltage through a reference line connected to a subpixel of the display panel.

3. The display device of claim 1, wherein the sensor is configured to sense the reference voltage through a power line connected to the subpixel of the display panel.

4. The display device of claim 2, wherein the sensor is configured to sense the reference voltage through the power line when the reference voltage applied through the reference line is transmitted through the power line of the display panel according to operation of a driving transistor included in the subpixel of the display panel.

5. The display device of claim 2, wherein the sensor is included in a power supply for generating the high power.

6. The display device of claim 2, wherein the sensor is configured to sense the reference voltage charged in the reference line when transistors included in the subpixel of the display panel are in a non-driving state.

7. The display device of claim 6, wherein the sensor is included in a data driver connected to the subpixel of the display panel.

8. The display device of claim 1, wherein the controller is configured to determine the display panel to be in an abnormal state when the reference voltage sensing value is detected as a level below a reference value.

9. A method of driving a display device, comprising:
applying a reference voltage lower than a high power to a display panel before the high power is applied to the display panel for driving the display panel;
sensing the reference voltage applied to the display panel before the high power is applied to the display panel to provide a reference voltage sensing value; and
diagnosing a state of the display panel on the basis of the reference voltage sensing value.

10. The method of claim 9, wherein the reference voltage is sensed through a power line connected to a subpixel of the display panel or through a reference line connected to the subpixel of the display panel.
